(19) United States
(12) Patent Application Publication
(10) Pub. No.: US 2012/0086906 A1
(43) Pub. Date: Apr. 12, 2012

(54) Apparatus and System for Assisting People with Scotopic Sensitivity Syndrome

(76) Inventor: Mark Reid, Burnaby (CA)

(21) Appl. No.: 13/269,420

(22) Filed: Oct. 7, 2011

Related U.S. Application Data
(60) Provisional application No. 61/391,156, filed on Oct. 8, 2010.
(60) Provisional application No. 61/627,043, filed on Sep. 19, 2011.

(51) Int. Cl. G02C 7/10; G02C 7/16; G02C 9/04

(52) U.S. Cl. 351/47; 351/44

(57) ABSTRACT

An apparatus and system for alleviating the symptoms of scotopic sensitivity syndrome for a user wearing eyeglasses is provided. The eyewear comprises one or more layers, a first band, and a second band. Each of the layers comprises a coloured film. The first and second bands are attached to the one or more layers. When the eyewear is in use, the one or more layers are placed in front of the eyeglasses and the first band is attached to the second band at a location behind the user's head. Systems for assisting in viewing a computer screen or printed matter are also provided.

### CROSS-REFERENCES TO RELATED APPLICATIONS

This application claims the benefit of U.S. Provisional Patent Application No. 61/391,156, filed Oct. 8, 2010 and U.S. Provisional Patent Application No. 61/627,043, filed Sep. 19, 2011, the contents of which are hereby incorporated herein by reference.

### FIELD OF THE INVENTION

The present invention relates to an apparatus and system for assisting people with scotopic sensitivity syndrome to read printed and computer-rendered matter and for doing activities in sunlight requiring good three-dimensional vision.

### BACKGROUND OF THE INVENTION

Scotopic sensitivity syndrome (SSS) is a visual perceptual disorder that impairs a person's ability to read. Symptoms include reduced three-dimensional vision; sensitivity to light, contrast, and patterns; reduced ability to distinguish colours; perceived distortions in text (such as letter reversals); and difficulty in reading printed text or computer displays. The syndrome was first recognized in the 1980s by Helen Irlen and Olive Meares. Typical treatment have included the use of tinted lenses and coloured overlays with a frosted surface for light diffusion. However, these devices are inadequate for people who are severely affected by SSS. For example, if tinted lenses are used in reading glasses, unfiltered light can still enter the eyes through the sides of the glasses, leading to discomfort and pain.

Also, in manufacturing tinted lenses that are comprised of several individual colours combined together, typically, both sides of the lenses are successively dyed with the individual colours. Because of this, the order of the colours in the tinted lenses is reversed on opposite sides of the lenses. For example, where A1 is the first colour, A2 is the second colour, and L is the lens, conventional tinted lenses would have a layering of A1-A2-L-A2-A1. In diagnosing SSS, it is common to combine filters of different colours in order to create a combination of filters that is optimal for a particular person. This combination of colours is then replicated through the tinted lenses. However, as explained above, during manufacturing of the tinted lenses, the colours are successively dyed onto both sides of the lens. This layering of colours may not completely correspond in effect with the use of the individual filters during diagnosis, leading to less-than-optimal results and distortion for the wearer.

Tinted contact lenses and tinted lenses for goggles have also been developed but they often result in wearers experiencing colour distortion. Furthermore, goggles are heavy and may be uncomfortable to wear. They may also give the wearer a feeling of claustrophobia. With respect to tinted contact lenses, some people are unable to wear contact lenses and so would not be able to use them.

It is therefore an object of the present invention to provide a convenient and comfortable apparatus and system for alleviating some of the symptoms of SSS while minimizing distortion for the user.

This and other objects of the invention will be better understood with reference to the detailed description of the invention which follows.

### SUMMARY OF THE INVENTION

The present invention provides an apparatus and system for alleviating the symptoms of scotopic sensitivity syndrome for a user wearing eyeglasses.

In one aspect of the invention, a set of eyewear is provided. The eyewear comprises one or more layers, a first band, and a second band. Each of the layers comprises a coloured film. The first and second bands are attached to the one or more layers. When the eyewear is in use, the one or more layers are placed in front of the eyeglasses and the first band is attached to the second band at a location behind the user's head.

In another aspect of the invention, the first band and the second band comprise elastic material.

In yet another aspect of the invention, each of the layers further comprises a sealed edge around a perimeter of each of the coloured film. The sealed edge may be made of a fabric polyester blend. The sealed edge may be glued or sewn to the perimeter of the coloured film.

In a further aspect of the invention, the set of eyewear further comprises one or more clips. When the eyewear is in use, the one or more clips attach the set of eyewear to the user's eyeglasses.

In another aspect of the invention, a system is provided for assisting a user wearing eyeglasses and suffering from scotopic sensitivity syndrome to read a computer screen. The system comprises a set of eyewear worn by the user, a screen filter, and a filter crop. The eyewear comprises one or more layers, a first band, and a second band. Each of the layers comprises a coloured film. The first and second bands are attached to the one or more layers. When the system is in use, the one or more layers are placed in front of the eyeglasses and the first band is attached to the second band at a location behind the user's head.

The screen filter comprises one or more layers of film placed over the computer screen to reduce the amount of light from the computer screen. The filter crop comprises a frame and a plurality of blocking pieces. The frame defines an interior opening. The blocking pieces are affixed to the frame, with the blocking pieces defining a slot in the interior opening of the frame. When the system is in use, the filter crop is held by the user at a distance away from the set of eyewear such that only a single line of text is visible on the computer screen through the slot.

In yet another aspect of the invention, a system is provided for assisting a user wearing eyeglasses and suffering from scotopic sensitivity syndrome to read printed matter. The system comprises a set of eyewear worn by the user and an overlay. The eyewear comprises one or more layers, a first band, and a second band. Each of the layers comprises a coloured film. The first and second bands are attached to the one or more layers. When the system is in use, the one or more layers are placed in front of the eyeglasses and the first band is attached to the second band at a location behind the user's head.

The overlay comprises a translucent covering defining an overlay slot. The overlay further comprises a slot film covering said overlay slot. When the system is in use, the overlay is held by the user at a distance away from the set of eyewear such that only a single line of text from the printed matter is visible through the slot film.

The foregoing was intended as a broad summary only and of only some of the aspects of the invention. It was not intended to define the limits or requirements of the invention. Other aspects of the invention will be inferred from the detailed description of the preferred embodiment and the claims.

### BRIEF DESCRIPTION OF THE DRAWINGS

The invention will be described by reference to the detailed description of the invention and to the drawings thereof in which:

FIG. 1 shows a front view of the eyewear according to the preferred embodiment of the invention;

FIG. 2a shows a right side view of the eyewear;

FIG. 2b shows a left side view of the eyewear;

FIG. 3 shows another view of the eyewear;

FIG. 4 shows a top view of the eyewear;

FIG. 5 shows a front view of an alternative embodiment of the eyewear;

FIG. 6 shows a front view of a further embodiment of the eyewear;

FIG. 7 shows the screen filter;

FIG. 8 shows a front view of the overlay;

FIG. 9 shows a side view of the overlay;

FIG. 10 shows a front view of the filter crop;

FIG. 11 shows a side view of the filter crop;

FIG. 12 shows a hat;

FIG. 13 shows a diagnostic sheet;

FIG. 14 shows the test gels used with the diagnostic sheet;

FIG. 15 shows the laminate layer used with the diagnostic sheet;

FIG. 16 shows an embodiment of the invention in which the eyewear is used with the filter crop and the screen filter for reading from a computer screen;

FIG. 17 shows an embodiment of the invention in which the eyewear is used with the overlay for reading from printed matter;

FIG. 18 shows a top view of an example of proper lighting for use with the invention; and

FIG. 19 shows a side view of FIG. 18.

### DETAILED DESCRIPTION OF THE PREFERRED EMBODIMENT

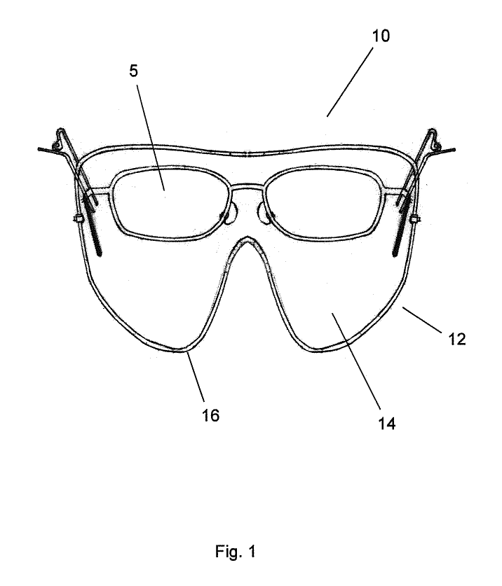

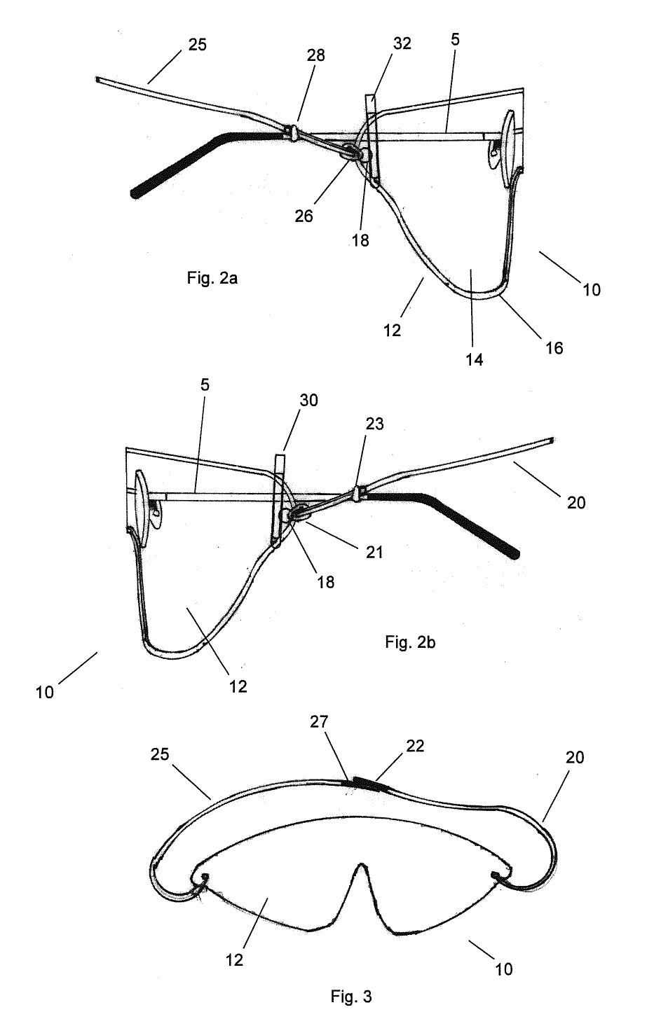

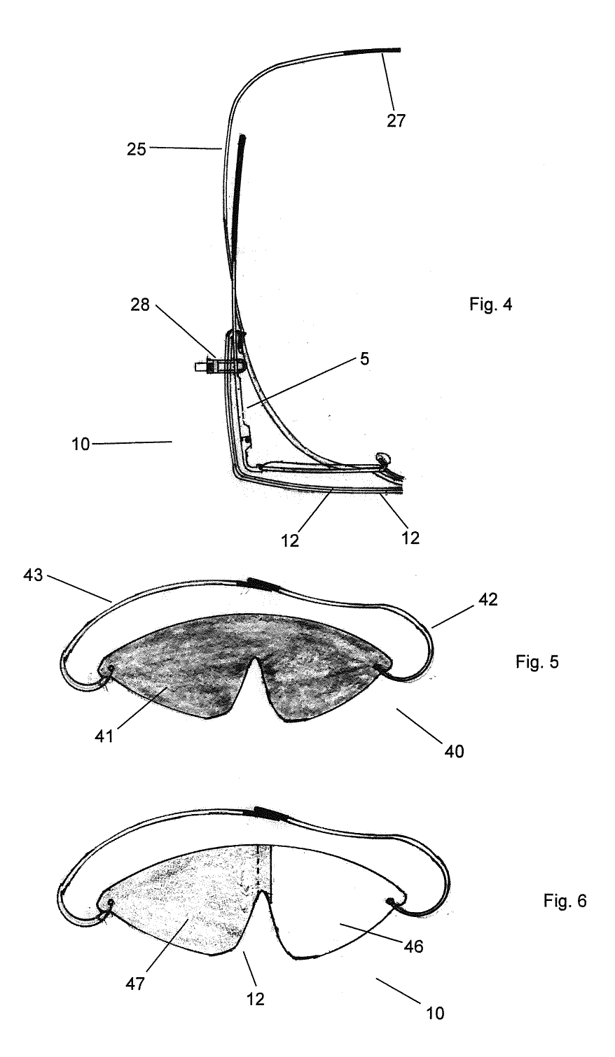

Referring to FIGS. 1 to 4, in one aspect of the invention, a set of eyewear 10 is provided. The eyewear 10 is designed to be used in conjunction with a set of conventional eyeglasses 5. The eyewear 10 comprises one or more layers 12, a first band 20, and a second band 25. Each of the layers 12 comprises a coloured film 14 and a sealed edge 16. Preferably, the coloured films 14 are made of a coloured gel material (such as polycarbonate), although they may also be made from plastic. One possible coloured film 14 is the Roscolux filter. The coloured films 14 are preferably flexible and are substantially uniform in shape to one another. Their shape follows the same general outline as the shape of the front of the pair of eyeglasses 5, although slightly larger in size than the pair of eyeglasses 5. Preferably, the lower edges of the layers 12 are shaped to tailor to the user's face so that there is substantially no gap between the lower edges of the layers 12 and the user's face, and the lower edges of the layers 12 do not protrude sharply into the user's skin. The coloured films 14 may be each of different colours, such that when combined, the coloured films 14 together result in a different colour from the individual coloured films 14. The coloured films 14 are preferably protected from scratching by applying a layer of wax and polishing the surface until smooth.

The sealed edge 16 runs along the outer edge of each of the layers 12 and is preferably made of a fabric cotton polyester blend, although other materials are also possible. The sealed edge 16 is preferably sewn or glued onto the edges of the coloured films 14. The layers 12 fit over the lenses of a pair of conventional eyeglasses, with the edges of the layers 12 extending beyond the edges of the lenses of the eyeglasses 5. Each of the layers 12 further comprises two holes 18 that are located on opposite ends of each layer 12, near the far edges of the layer 12. The holes 18 extend through each of the layers 12 at substantially the same location on each layer 12. The holes 18 are located so that a slight downward pressure on the lower edges of the layers 12 against the face of the user creates a light seal.

The first band 20 is preferably made of an elastic material, with a first loop 21 formed at or near one end of the first band 20 and a first fastener attachment 22 near the other end. Similarly, the second band 25 is also preferably made of an elastic material, with a second loop 26 formed at or near one end of the second band 25 and a second fastener attachment 27 near the other end. The first loop 21 is placed through all of the holes 18 located on one end of the layers 12, while the second loop 26 is placed through all of the holes 18 located on the other end of the layers 12. The other end of the first band 20 (i.e. the end not containing the loop 21) is placed through the loop 21, and a knot 23 is formed on the first band 20 near the location of the holes 18 in order to securely attach the first band 20 to the layers 12. Similarly, the other end of the second band 25 (i.e. the end not containing the loop 26) is placed through the loop 26, and a knot 28 is formed on the second band 25 near the location of the holes 18 in order to securely attach the second band 25 to the layers 12.

The first and second fastener attachments 22, 27 preferably form two parts of a hook-and-loop fastener (such as those sold under the VELCRO trademark), although other types of fastener arrangements (such as buckles or clips) are also possible. Preferably, the first and second fastener attachments 22, 27 are adjustable to fit the diameter of the user's head. The first and second fastener attachments 22, 27 allow the first band 20 and the second band 25 to be easily connected together and disconnected from each other. When the first and second fastener attachments 22, 27 are connected and the eyewear 10 is placed around the user's head and on top of the user's eyeglasses 5, the elastic tension of the first and second bands 20, 25 pull the layers 12 snug across the forward surface of the lenses of the eyeglasses 5. Because the size of the layers 12 is somewhat larger than the lenses of the eyeglasses 5, the elastic tension created by the first and second bands 20, 25 also cause the sealed edges 16 of the layers 12 to wrap around the edges of the lenses of the eyeglasses 5. This wrapping of the layers 12 around the lenses of the eyeglasses 5 provide additional filtering for light that enters around the edges of the lenses of the eyeglasses 5 by creating a snug fit across the face of the user. The sealed edges 16 prevent the edges of the coloured films 14 from cutting into the skin of the user and provide greater comfort to the user.

The eyewear 10 further comprises a first clip 30 and a second clip 32. The first clip 30 is located near the attachment of the first band 20 to the holes 18, while the second clip 32 is located near the attachment of the second band 25 to the holes 18. The first and second clips 30, 32 help to hold the layers 12 together and also clips the layers 12 to the arms of the eyeglasses 5.

The coloured films 14 act to reduce the intensity of the light passing through the user's eyeglasses 5, which help to alleviate some of the symptoms of SSS. Furthermore, the colour filtering effect of the coloured films 14 serve to further alleviate the symptoms. The precise colours or colour combinations for the coloured films 14 that will provide the greatest relief to the user suffering from SSS may vary from person to person and can be determined in a manner described further below.

In bright sunlight or outdoor lighting conditions, the light intensity may be further reduced to alleviate the symptoms of SSS. Referring to FIG. 5, in an alternative embodiment, a light filter 40 made of a neutral density gel 41 (i.e. a grey filter) may be placed over top the layers 12 of the eyewear 10. The light filter 40 is substantially similar in shape to the eyewear 10 and comprises first light filter band 42 and second light filter band 43. The first and second light filter bands 42, 43 are attached to the neutral density gel 41 in the same manner that the first and second bands 20, 25 are attached to the layers 12. Furthermore, the first and second light filter bands 42, 43 comprise the same attachment mechanisms as the first and second bands 20, 25. As with the first and second bands 20, 25, the first and second light filter bands 42, 43 are preferably elastic and can be used to hold the light filter 40 on top of the layers 12. As the light intensity changes through the day, other light filters 40, with a different neutral density layer that is either darker or lighter, may be used as required by the changing light conditions.

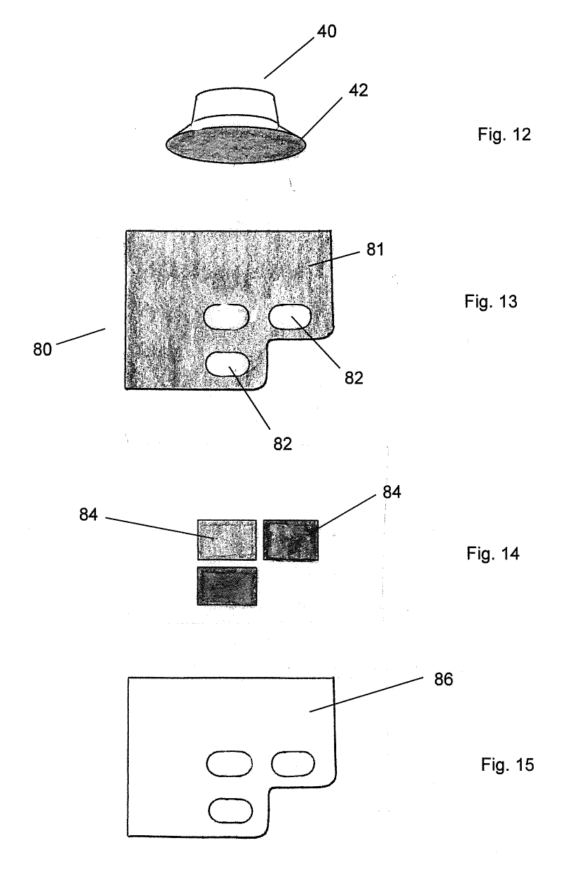

Referring to FIG. 12, the eyewear 10 is preferably used in conjunction with a hat 40. The hat 40 should have a brim 42 that is wide enough to shade the gap between the top edges of the layers 12 of the eyewear 10 and the face of the user from unfiltered light. For optimum shading, the underside of the brim 42 should be black or some other dark colour.

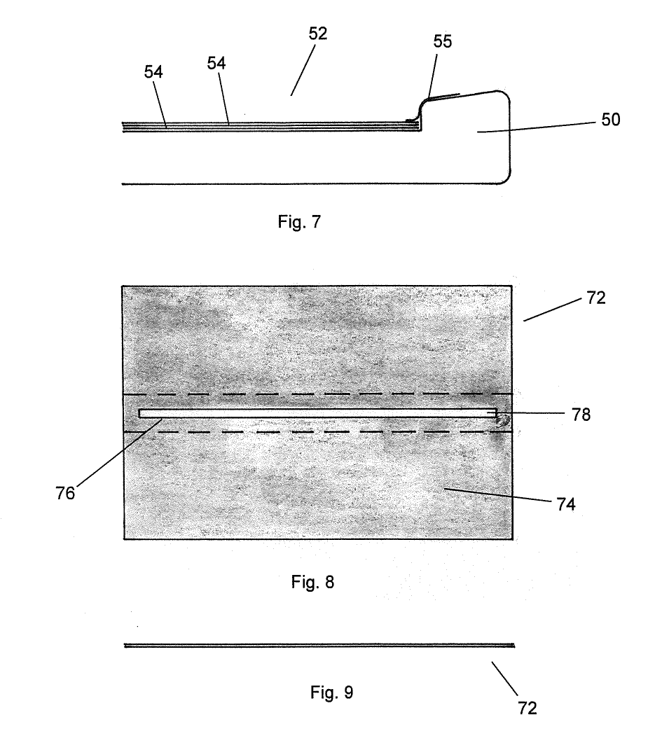

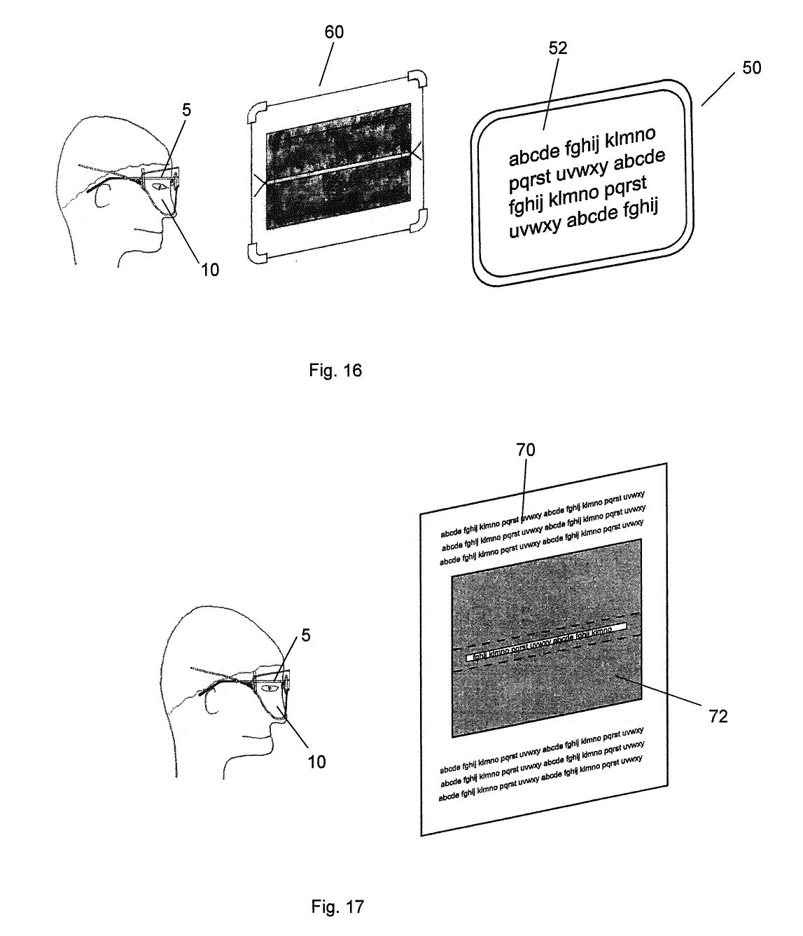

Referring to FIGS. 7 and 16, when reading from a computer screen 50 or the like, the eyewear 10 may also be used in conjunction with a screen filter 52. FIG. 7 shows a cross-sectional view from the side of the computer screen 50. The screen filter 52 comprises one or more layers of film 54 placed over the computer screen 50. The screen filter 52 filters excess light. The layers of film 54 preferably comprise layers of clear cellophane, although other materials are also possible. In order to determine the appropriate number of layers of film 54 to use, the computer screen 50 may be set to maximum resolution with the quickest refresh rate. The brightness and contrast of the computer screen 50 may also be set to their respective lowest settings. Layers of film 54 can then be added one at a time until no more improvement in image quality is observed, and the pain from the bright light is alleviated. The layers of film 54 may be attached to the computer screen using tape 55, or other suitable attachment means.

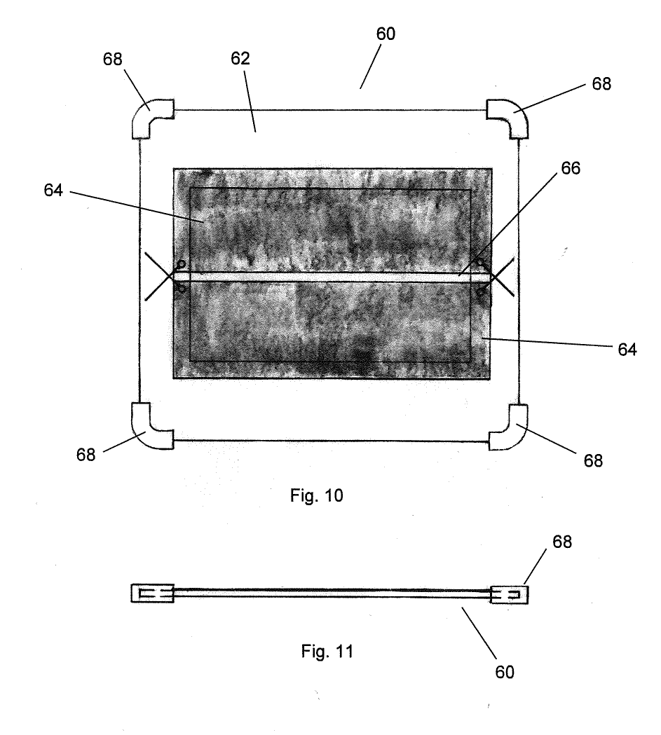

Furthermore, referring to FIGS. 10, 11, and 16, a filter crop 60 can also be used in conjunction with the eyewear 10 and screen filter 52 when reading from a computer screen 50 or the like. The filter crop 60 may be hand-held and comprises a frame 62 made of a thin layer of closed cell foam or other light-weight material (such as paper) that has been laminated between two layers of clear plastic film. In the middle of the frame 62, two blocking pieces 64 are arranged, forming a slot 66 in between the two blocking pieces. The blocking pieces 64 are made of a neutral grey plastic film. Preferably, the blocking pieces 64 are glued or taped in place on the frame 62. The edges of the blocking pieces 64 adjacent to the slot 66 may be tensioned with pieces of elastic thread to keep the edges taunt and straight. The threads are attached to the frame 62 and looped through a hole in the blocking piece 64 and a knot is tied. The thread is pulled to create a tension in the thread, and the knot is tightened up. When the thread is released, the blocking piece 64 is held in place by the tension in the thread. A second knot is then added to lock the blocking piece 64 in place. Any excess thread can be trimmed off. Preferably, the corners 68 of the frame 62 are covered with foam or rubber or other light-weight material to prevent injury to the user in case the filter crop 60 is dropped or thrown. In another embodiment, the entire perimeter of the frame 62 may be covered in this manner. The filter crop 60 is hand-held between the eyewear 10 and the computer screen 50, and is put into use by holding it above the text on the computer screen 50, at a distance away from the computer screen 50. The slot 66 is kept aligned with the text and the distance of the filter crop 60 from the computer screen 50 can be varied. The filter crop 60 can also be tipped to vary the amount of text visible through the slot to accommodate different-sized text. The tipping also varies the density of the filter, so the filter crop 60 is an adjustable filter (i.e. when the filter crop 60 is tipped, the filtered text seen through the blocking pieces 64 appears darker). Preferably, only one line of text would be visible through the slot 66.

If instead of a computer screen 50, the user is reading from printed matter 70, an overlay 72 may be used in conjunction with the eyewear 10 instead of the filter crop 60. As shown in FIGS. 8, 9, and 17, the overlay 72 comprises a translucent covering 74 with an overlay slot 76 in the middle of the covering 74. The covering 74 is preferably made of a neutral gray plastic or polycarbonate film. The overlay slot 76 comprises a clear slot film 78. The slot film 78 is almost clear. The covering 74 preferably has a smooth (shiny) surface and a textured surface on the other side. The smooth surface is on the side facing the printed matter 70. The nature of the overlay 72 reduces the amount of light reflecting off it. The overlay 72 may be any appropriate size, although preferably it will have a similar size to the dimensions of the printed matter 70. The overlay 72 may be moved over the text of the printed matter 70 one line at a time as the user reads the text. Different densities of the covering 74 may be selected. Different grades of diffusion can be used for the slot film 78 as well. When in use, the overlay 72 is preferably placed directly on top of the printed matter 70 such that only one line of text is visible through the overlay slot 76.

In order to determine the appropriate layers 12 to be used for the eyewear 10, a diagnostic sheet 80 may be used. Referring to FIGS. 13 to 15, the diagnostic sheet 80 preferably comprises a front board 81 and one or more coloured test gels 84. The front board 81 may be black cardboard paper or heavy film of plastic or other sheet material. A number of small slotted colour holes 82 are formed throughout the front board 81. Preferably, each of the colour holes 82 is preferably three-sixteenth inch by seven-sixteenth inch, although other sizes are possible. A piece of coloured test gel 84 is placed beneath the front board 81, in each of the colour holes 82. The coloured test gels 84 may be glued in place. Furthermore, a laminate backing 86 may be applied to the back of the diagnostic sheet 80 to hold coloured test gels 84 in place. Preferably, a different colour or combination of colours of coloured test gel 84 is placed in each of the colour holes 82. To use the diagnostic sheet 80, it is laid over a page of type so that a portion of the text material is visible through each of the colour holes 82. The user can then quickly scan all of the colour holes 82 and select the one that appears to be the clearest and easiest to read. The diagnostic sheet 80 can also be used in conjunction with the computer screen 50 to determine the best colour or colour combination for use with the computer screen 50 by holding the diagnostic sheet 80 up to the user's eye and viewing the computer screen 50 through the colour holes 82. The user may attempt to further improve the effect by adding a second layer of colour by placing a second sheet of gel with the same colour as first selected between the diagnostic sheet 80 and the page of text and then re-scanning through the colour holes 82 to see if there is any more improvement. The optimal colour or colour combination of the coloured test gel 84 can then be used to determine the coloured films 14 to be used for the eyewear 10.

The user's two eyes may each require different colours or different colour combinations from each other. In another embodiment shown in FIG. 6, if different colours or different colour combinations are required for each eye, one or more of the layers 12 may comprise a first half 46 and a second half 47. Each of the first half 46 and the second half 47 may comprise a different coloured film from each other. The first half 46 may be sewn to the second half 47. In this way, each of the user's eyes can experience different colours or different colour combinations from the other eye.

The eyewear 10 is light-weight and comfortable, provide enhanced peripheral vision, and do not result in the claustrophobic feeling one gets from using goggles. The colours in the layers 12 are the same as what was used to diagnose the user using the diagnostic sheet 80 so there is no distortion of colour, compared to conventional tinted eyeglasses. With the eyewear 10 and associated components, the symptoms of SSS are alleviated, and a user is able to read from the computer screen 50 or from printed matter 70 for extended periods of time without significant discomfort.

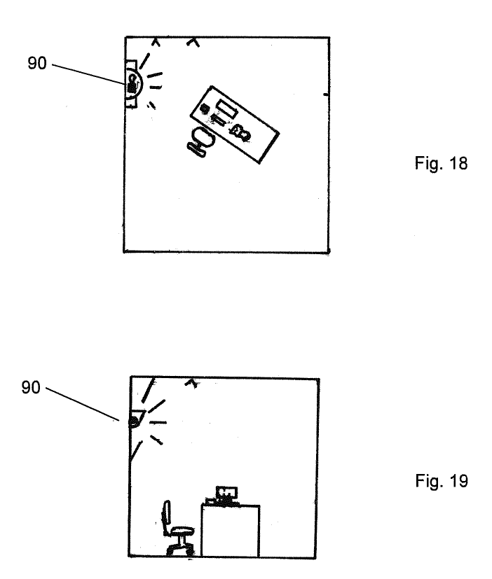

Referring to FIGS. 18 and 19, preferably, when using system or the components of the system, the ambient lighting should be adjusted to maximize the effectiveness of the components. Typically, incandescent lighting is best, with a bulb 90 of approximately 100 W brightness. For reading printed matter 70, the bulb 90 should be uncovered, placed at the ceiling of the room, approximately six feet away and at 90 degrees to the line of sight of the user. For reading the computer screen 50, a diffusion lens should be used with the bulb 90. The area around the computer screen 50 should be backlit to prevent eyestrain, and the area behind the user should be shaded to prevent reflections forming on the computer screen 50. The walls of the room should preferably be painted a light off-white/yellow or beige colour with a satin finish. It is preferable to not have direct sunlight impacting the printed matter 70 or the computer screen 50.

Although the preferred embodiment and alternative embodiments have been described herein, it will be appreciated that the scope of the invention is not intended to be restricted thereby, such scope instead being discerned from a combination of such disclosure and the claims that follow.

1. An apparatus for alleviating the symptoms of scotopic sensitivity syndrome for a user wearing eyeglasses, said apparatus comprising:
a set of eyewear, said set of eyewear to be worn by said user and comprising:
one or more layers, each of said layers comprising a coloured film;
a first band, wherein one end of said first band is attached to said one or more layers; and
a second band, wherein one end of said second band is attached to said one or more layers;
wherein, when said apparatus is in use, said one or more layers are placed in front of said eyeglasses and said first band is attached to said second band at a location behind said user's head.

2. The apparatus of claim 1, wherein said first band and said second band comprise elastic material.

3. The apparatus of claim 1, wherein each of said layers further comprises a sealed edge around a perimeter of each of said coloured film.

4. The apparatus of claim 3, wherein said sealed edge is made of a fabric polyester blend.

5. The apparatus of claim 3, wherein said sealed edge is sewn to said perimeter of said coloured film.

6. The apparatus of claim 3, wherein said sealed edge is glued to said perimeter of said coloured film.

7. The apparatus of claim 1, wherein said set of eyewear further comprises one or more clips, wherein, where said system is in use, said one or more clips attach said set of eyewear to said eyeglasses.

8. A system for assisting a user wearing eyeglasses and with scotopic sensitivity syndrome, said system comprising:
a set of eyewear, said set of eyewear to be worn by said user and comprising:
one or more layers, each of said layers comprising a coloured film;
a first band, wherein one end of said first band is attached to said one or more layers; and
a second band, wherein one end of said second band is attached to said one or more layers;
wherein, when said system is in use, said one or more layers are placed in front of said eyeglasses and said first band is attached to said second band at a location behind said user's head;
a screen filter, said screen filter comprising one or more layers of film placed over said computer screen to reduce the amount of light from said computer screen;
a filter crop, said filter crop comprising:
a frame, said frame defining an interior opening;
a plurality of blocking pieces affixed to said frame, said blocking pieces defining a slot in said interior opening of said frame;
wherein, when said system is in use, said filter crop is held by said user at a distance away from said set of eyewear such that only a single line of text is visible on said computer screen through said slot.

9. The system of claim 8, wherein said first band and said second band comprise elastic material.

10. The system of claim 8, wherein each of said layers further comprises a sealed edge around a perimeter of each of said coloured film.

11. The system of claim 10 wherein said sealed edge is made of a fabric polyester blend.

12. The system of claim 10, wherein said sealed edge is sewn to said perimeter of said coloured film.

13. The system of claim 10, wherein said sealed edge is glued to said perimeter of said coloured film.

14. The system of claim 8, wherein said set of eyewear further comprises one or more clips, wherein, where said system is in use, said one or more clips attach said set of eyewear to said eyeglasses.

15. A system for assisting a user wearing eyeglasses with scotopic sensitivity syndrome to read printed matter, said system comprising:
a set of eyewear, said set of eyewear to be worn by said user and comprising:
one or more layers, each of said layers comprising a coloured film;
a first band, wherein one end of said first band is attached to said one or more layers; and
a second band, wherein one end of said second band is attached to said one or more layers;
wherein, when said system is in use, said one or more layers are placed in front of said eyeglasses and said first band is attached to said second band at a location behind said user's head; and
an overlay, said overlay comprising:
a translucent covering defining an overlay slot; and
a slot film covering said overlay slot;
wherein, when said system is in use, said overlay is held by said user at a distance away from said set of eyewear such that only a single line of text from said printed matter is visible through said slot film.

16. The system of claim 15, wherein said first band and said second band comprise elastic material.

17. The system of claim 15, wherein each of said layers further comprises a sealed edge around a perimeter of each of said coloured film.

18. The system of claim 17, wherein said sealed edge is made of a fabric polyester blend.

19. The system of claim 17, wherein said sealed edge is sewn or glued to said perimeter of said coloured film.

20. The system of claim 15, wherein said set of eyewear further comprises one or more clips, wherein, where said system is in use, said one or more clips attach said set of eyewear to said eyeglasses.
